(19) United States
(12) Patent Application Publication
(10) Pub. No.: US 2011/0228149 A1
(43) Pub. Date: Sep. 22, 2011

(54) SOLID-STATE IMAGING DEVICE

(76) Inventors: Junji NARUSE, Yokohama-shi (JP); Nagataka Tanaka, Yokohama-shi (JP)

(21) Appl. No.: 13/051,095

(22) Filed: Mar. 18, 2011

(30) Foreign Application Priority Data
Mar. 19, 2010 (JP) 2010-064742

(51) Int. Cl. H04N 5/335

(52) U.S. Cl. 348/273; 348/E05.091

(57) ABSTRACT

According to one embodiment, a solid-state imaging device includes a photodiode module in which first photodiodes corresponding to high-sensitivity pixels and second photodiodes corresponding to low-sensitivity pixels are alternately arranged at preset pitch P in a semiconductor substrate, high-sensitivity pixel interconnection lines formed at preset pitch C on the substrate, low-sensitivity pixel interconnection lines that are formed at preset pitch D on the substrate, high-sensitivity pixel color filters formed at preset pitch A on the opposite side of the respective interconnection lines with respect to the substrate, and low-sensitivity pixel interconnection lines that are formed at preset pitch B on the other side of the interconnection lines with respect to the substrate. The relationship between the above pitches is set to D=B<P<A=C.

### CROSS-REFERENCE TO RELATED APPLICATIONS

This application is based upon and claims the benefit of priority from Japanese Patent Application No. 2010-064742, filed Mar. 19, 2010; the entire contents of which are incorporated herein by reference.

### FIELD

Embodiments described herein relate generally to a solid-state imaging device including unit pixels each of which is configured by two types of pixels including high-sensitivity and low-sensitivity pixels.

### BACKGROUND

Recently, the technique for arranging high-sensitivity pixels and low-sensitivity pixels adjacent to one another in an imaging region in a solid-state imaging device such as a CCD image sensor or CMOS image sensor to expand the dynamic range is proposed. In this device, the aperture larger than a pixel pitch is set for the high-sensitivity pixel (the diameter of a microlens is large) and the aperture smaller than the pixel pitch is set for the low-sensitivity pixel (the diameter of a microlens is small).

However, in this type of device, the following problem occurs. That is, since the aperture larger than a pixel pitch is set for the high-sensitivity pixel, light is made incident on the high-sensitivity pixel at a large angle. At this time, since the interconnection pitches of the high-sensitivity pixels and low-sensitivity pixels are both set equal to the pixel pitch, the aperture becomes larger than the interconnection pitch. Therefore, light made incident with a large angle is shielded by the interconnection layer of the high-sensitivity pixel and there occurs a problem that a so-called eclipse occurs.

### BRIEF DESCRIPTION OF THE DRAWINGS

FIG. 1 is a block diagram showing the schematic configuration of a CMOS image sensor according to a first embodiment.

FIGS. 2A, 2B are views each schematically showing a part of a layout image of the CMOS image sensor of FIG. 1.

FIG. 3 is a diagram for illustrating the operation timings and potentials of the CMOS image sensor of FIG. 1 (high-illumination mode).

FIG. 4 is a diagram for illustrating the operation timings and potentials of the CMOS image sensor of FIG. 1 (low-illumination mode).

FIG. 5 is a characteristic diagram for illustrating the dynamic range expansion effect in the CMOS image sensor of FIG. 1.

FIG. 6 is a cross-sectional view showing the arrangement relationship between microlenses, interconnection lines and pixels in the first embodiment.

FIG. 7 is a cross-sectional view showing a state in which light with a high angle of incidence is made incident in the first embodiment.

FIG. 8 is a view schematically showing a part of a layout image of a CMOS image sensor according to a modification of the first embodiment.

FIG. 9 is a cross-sectional view showing the positional relationship between microlenses, interconnection lines and pixels in a second embodiment.

FIG. 10 is a cross-sectional view showing a state in which light with a high angle of incidence is made incident in the second embodiment.

FIG. 11 is a cross-sectional view showing the positional relationship between microlenses, interconnection lines and pixels in a third embodiment.

FIG. 12 is a cross-sectional view showing the positional relationship between microlenses, interconnection lines and pixels in a fourth embodiment.

### DETAILED DESCRIPTION

In general, according to one embodiment, a solid-state imaging device includes a photodiode module in which first photodiodes corresponding to high-sensitivity pixels and second photodiodes corresponding to low-sensitivity pixels are alternately arranged at preset pitch P in a semiconductor substrate, high-sensitivity pixel interconnection lines formed at preset pitch C on the substrate, low-sensitivity pixel interconnection lines that are formed at preset pitch D on the substrate, high-sensitivity pixel color filters formed at preset pitch A on the opposite side of the respective interconnection lines with respect to the substrate to limit the wavelength of incident light to the high-sensitivity pixels, and low-sensitivity pixel interconnection lines that are formed at preset pitch B on the other side of the interconnection lines with respect to the substrate to limit the wavelength of incident light to the low-sensitivity pixels. The relationship between the above pitches is set to D=B<P<A=C.

Next, an embodiment is explained with reference to the drawings.

### First Embodiment

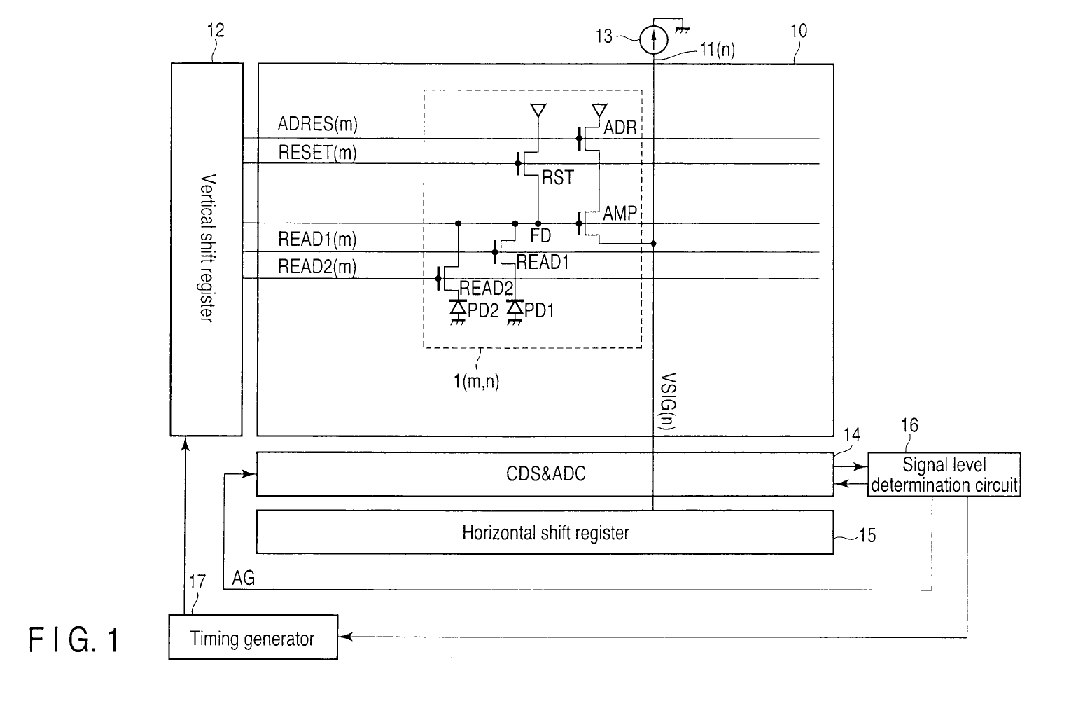

FIG. 1 is a block diagram schematically showing a CMOS image sensor according to a first embodiment. The whole configuration of the CMOS image sensor is the same as that in different embodiments that will be described later.

An imaging region 10 includes a plurality of unit pixels (unit cells) 1(m, n) arranged in m rows and n columns. In this example, one unit cell 1(m, n) of the mth row and nth column among the unit cells and one vertical signal line 11(n) among vertical signal lines formed in a column direction corresponding to respective columns of the imaging region are shown as a representative.

On one-end side of the imaging region 10 (on the left side of the drawing), a vertical shift register 12 that supplies pixel drive signals such as ADRES(m), RESET(m), READ1(m), READ2(m) to the respective rows of the imaging region is arranged.

On the upper-end side of the imaging region 10 (on the upper side of the drawing), a current source 13 connected to the vertical signal line 11(n) of each column is arranged. The current source 13 is operated as a part of a pixel source follower circuit.

On the lower-end side of the imaging region (on the lower side of the drawing), a CDS/ADC 14 including a correlated double sampling (CDS) circuit and analog-to-digital conversion (ADC) circuit connected to the vertical signal line 11(n) of each column and a horizontal shift register 15 are arranged. The CDS/ADC 14 subjects an analog output of the pixel to a CDS process and converts the same to a digital output.

A signal level determination circuit 16 determines whether output signal VSIG(n) of the unit cell is smaller or larger than a preset value based on the level of an output signal digitized by the CDS/ADC 14. Then, the circuit supplies the determination output to a timing generator 17 and supplies the same as an analog gain control signal to the CDS/ADC 14.

The timing generator 17 generates an electronic shutter control signal for controlling the storage time of the photodiode, a control signal for switching the operation modes and the like at respective preset timings and supplies the same to the vertical shift register 12.

Each unit cell has the same circuit configuration and, in this embodiment, one high-sensitivity pixel and one low-sensitivity pixel are arranged in each unit cell. In this case, the configuration of the unit cell 1(m, n) in FIG. 1 is explained.

The unit cell 1(m, n) includes photodiode PD1 that photoelectrically converts incident light to store converted charges, first read transistor READ1 that is connected to PD1 and reads signal charges of PD1, second photodiode PD2 that photoelectrically converts incident light to store converted charges and is lower in light sensitivity than PD1, and second read transistor READ2 that is connected to PD2 and reads signal charges of PD2. The unit cell further includes floating diffusion node FD that is connected to one-side terminals of READ1, READ2 and temporarily stores signal charges read by means of READ1, READ2, amplification transistor AMP whose gate is connected to FD and that amplifies a signal of FD and outputs the same to the vertical signal line 11(n), reset transistor RST whose source is connected to the gate potential (FD potential) of AMP to reset the gate potential and select transistor ADR that controls supply of a power source voltage to AMP to select and control a unit cell in a desired horizontal position in the vertical direction. Each of the above transistors is an n-type MOSFET in this example.

ADR, RST, REAS1, READ2 are controlled by signal lines ADRES(m), RESET(m), READ1(m), READ2(m) of a corresponding row. Further, one end of amplification transistor AMP is connected to the vertical signal line 11(n) of a corresponding column.

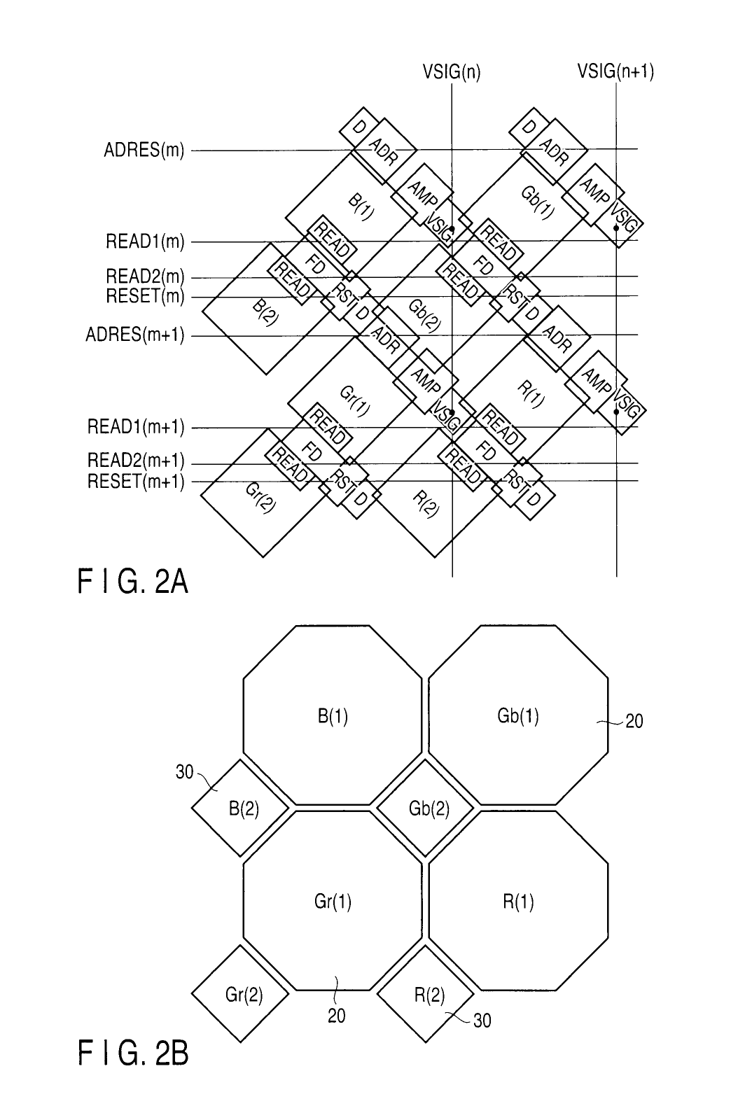

FIG. 2A is a view schematically showing the layout image of an element-forming region and gates of an extracted portion of the imaging region of the CMOS image sensor of FIG. 1. FIG. 2B is a view schematically showing the layout image of color filters/microlenses of an extracted portion of the imaging region of the CMOS image sensor of FIG. 1. The arrangement of the color filters•microlenses utilizes a normal RGB Bayer array.

In FIGS. 2A, 2B, R(1), R(2) indicate regions corresponding to an R pixel, B(1), B(2) indicate regions corresponding to a B pixel and Gb(1), Gb(2), Gr(1), Gr(2) indicate regions corresponding to a G pixel. D indicates a drain region. Further, signal lines ADRES(m), RESET(m), READ1(m), READ2(m) of an mth row, signal lines ADRES(m+1), RESET(m+1), READ1(m+1), READ2(m+1) of an (m+1)th row, vertical signal line 11(n) of an nth column and vertical signal line 11(n+1) of an (n+1)th column are shown to indicate the correspondence relationship of the signal lines.

For simplifying the explanation, in FIG. 2A, various signal lines are indicated to overlap with the pixels, but in practice, the various signal lines are arranged to pass through the peripheral portions of the pixels without overlapping with the pixels.

As shown in FIGS. 2A, 2B, the high-sensitivity pixel and low-sensitivity pixel are arranged in the unit cell. Color filters and microlenses 20 with a large area are placed on the high-sensitivity pixels and color filters and microlenses 30 with a small area are placed on the low-sensitivity pixels.

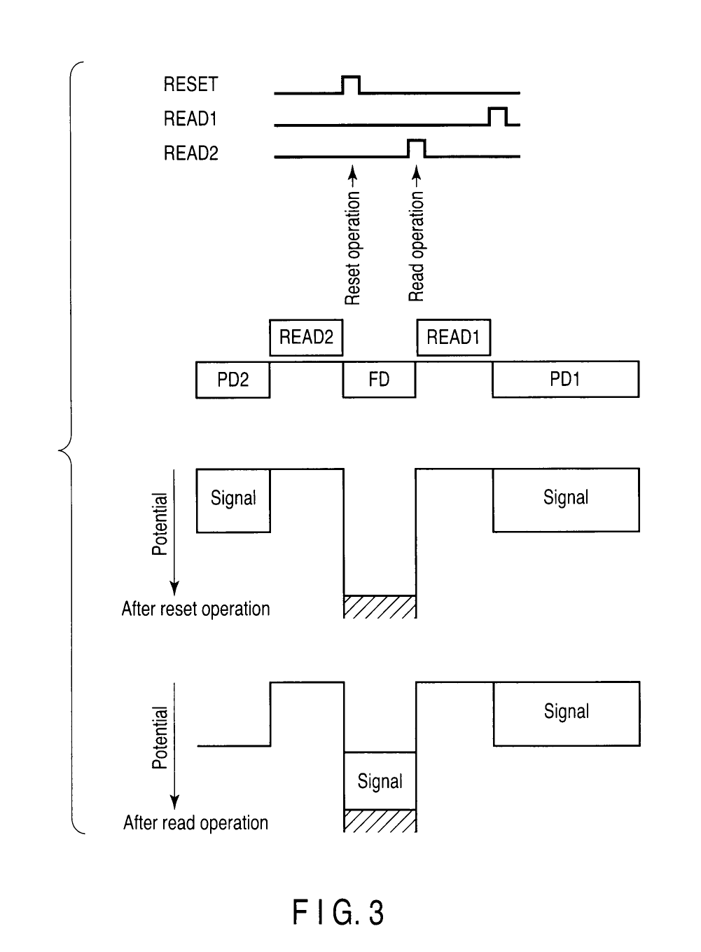

FIG. 3 is a diagram showing one example of the operation timings of a pixel in a low-sensitivity mode, a potential in the semiconductor substrate at the reset operation time and a potential at the read operation time in the CMOS image sensor of FIG. 1. In this case, the low-sensitivity mode is a mode suitable for a case wherein the amount of signal charges stored in PD1, PD2 is large (bright time). When the amount of signal charges of FD is large as in the low-sensitivity mode, it is required to expand the dynamic range while the sensitivity of the sensor is lowered to prevent the sensor from being saturated as far as possible.

First, RST is turned on to perform the reset operation and then the potential of FD immediately after the reset operation is set equal to the potential level of the drain (the power source of the pixel). After the end of the reset operation, RST is turned off. Then, a voltage corresponding to the potential of FD is output to the vertical signal line 11. The voltage is fetched in a CDS circuit of the CDS/ADC 14 (dark-time level).

Next, READ1 or READ2 is turned on to transfer signal charges stored so far in PD1 or PD2 to FD. In the low-sensitivity mode, the read operation of turning on only READ2 and transferring only signal charges stored in PD2 with lower sensitivity to FD is performed. At the transfer time of signal charges, the FD potential is changed. Since a voltage corresponding to the potential of FD is output to the vertical signal line 11, the voltage is fetched in the CDS circuit (signal level). After this, noises such as variation in Vth (threshold value) of AMP are canceled by subtracting the dark-time level from the signal level in the CDS circuit and only a pure signal component is extracted (CDS operation).

For simplifying the explanation, in the low-sensitivity mode, the explanation for the operations of PD1 and READ1 is omitted. In practice, it is preferable to discharge signal charges stored in PD1 by turning on READ1 immediately before the reset operation of FD is performed to prevent signal charges of PD1 from overflowing to FD. Further, READ1 may always be kept on in a period other than a period in which the reset operation of FD and the read operation of a signal from PD2 are performed.

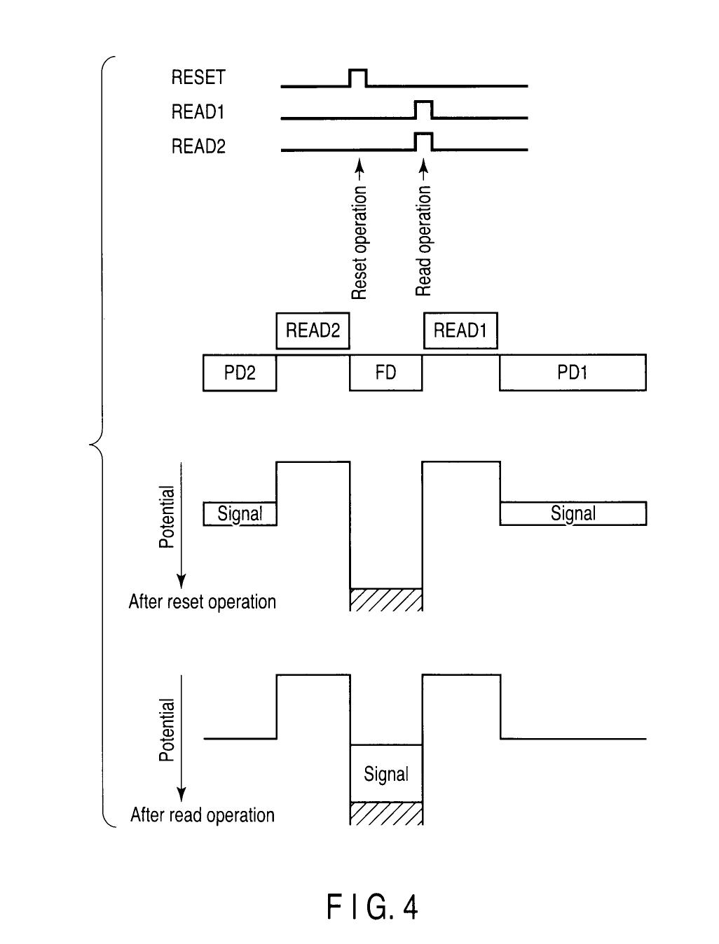

FIG. 4 is a diagram showing one example of the operation timings of a pixel in the high-sensitivity mode, a potential in the semiconductor substrate at the reset operation time and a potential at the read operation time in the CMOS image sensor of FIG. 1. In this case, the high-sensitivity mode is a mode suitable for a case wherein the amount of signal charges stored in FD is small (dark time). When the amount of signal charges of FD is small as in the high-sensitivity mode, it is required to enhance the S/N ratio by enhancing the sensitivity of the CMOS image sensor.

First, RST is turned on to perform the reset operation and then the potential of FD immediately after the reset operation is set equal to the potential level of the drain (the power source of the pixel). After the end of the reset operation, RST is turned off. Then, a voltage corresponding to the potential of FD is output to the vertical signal line 11. The voltage is fetched in a CDS circuit of the CDS/ADC 14 (dark-time level).

Next, READ1, READ2 are turned on to transfer signal charges stored so far in PD1 and PD2 to FD. In the high-sensitivity mode, the read operation of turning on both of READ1 and READ2 and transferring all of signal charges acquired in the dark state to FD is performed. At the transfer time of signal charges, the FD potential is changed. Since a voltage corresponding to the potential of FD is output to the vertical signal line 11, the voltage is fetched in the CDS circuit (signal level). After this, noises such as variation in Vth of AMP are canceled by subtracting the dark-time level from the signal level and only a pure signal component is extracted (CDS operation).

Generally, thermal noise generated in AMP and 1/f noise occupy a large part of entire noises generated in the CMOS image sensor. Therefore, an increase in the signal level by adding a signal at the stage of transferring the signal to FD before noise is generated as in the CMOS image sensor of the present embodiment is advantageous in enhancing the S/N ratio. Further, since the number of pixels is reduced by adding a signal at the stage of transferring the signal to FD, the effect that the frame rate of the CMOS image sensor can be easily raised is obtained.

The adding operation is not limited to addition of signal charges in FD. Signal charges of PD1, PD2 may be separately output by use of a pixel source follower circuit. In this case, not simple addition of signal charges of PD1, PD2 but weighted addition with the ratio of 2:1, for example, may be performed in a signal processing circuit outside the CMOS image sensor.

As described above, in this embodiment, one high-sensitivity pixel and one low-sensitivity pixel are arranged in each unit cell in the CMOS image sensor. When the signal charge amount is small, both of the signals of the high-sensitivity pixel and low-sensitivity pixel are used. At this time, it is preferable to add and read signal charges in the unit cell. Further, when the signal charge amount is large, only the signal of the low-sensitivity pixel is used. Thus, the two operation modes are selectively used.

Since one high-sensitivity pixel and one low-sensitivity pixel are arranged in each unit cell in this embodiment, the relationship of the following equations (1) may be considered to be set. That is, suppose that the light sensitivity/saturation level of the conventional pixel, the light sensitivity/saturation level of the high-sensitivity pixel and the light sensitivity/saturation level of the low-sensitivity pixel are expressed as follows:

Light sensitivity of conventional pixel: SENS

Saturation level of conventional pixel: VSAT

Light sensitivity of high-sensitivity pixel: SENS1

Saturation level of high-sensitivity pixel: VSAT1

Light sensitivity of low-sensitivity pixel: SENS2

Saturation level of low-sensitivity pixel: VSAT2

Then, the following equations are obtained.

SENS=SENS1+SENS2, VSAT=VSAT1+VSAT2 (1)

If the high-sensitivity pixel is saturated and the mode is switched to a low-sensitivity mode, the signal charge amount obtained is reduced and the S/N ratio is lowered. A light amount by which the high-sensitivity pixel is saturated is expressed by VSAT1/SENS1. A signal output of the low-sensitivity pixel with the above light amount becomes VSAT1×SENS2/SENS1. Therefore, the reduction rate of the signal output with the light amount is expressed by the following equation.

(VSAT1×SENS2/SENS1)/(VSAT1×SENS/SENS1)=SENS2/SENS (2)

Since it is desired to avoid a lowering in the signal at the switching time of high-sensitivity/low-sensitivity modes, it is considered adequate to set SENS2/SENS between 10% and 50%. In this embodiment, SENS2/SENS is set to ¼=25%.

On the other hand, the dynamic range expanding effect is expressed by the following expression by taking the ratio of the maximum incident light amount VSAT2/SENS2 in the low-sensitivity mode to the maximum incident light amount (dynamic range) VSAT/SENS of the conventional pixel.

(VSAT2/VSAT)×(SENS/SENS2) (3)

As is clearly understood from expression (3), it is preferable to increase VSAT2/VSAT as far as possible. This means that it is preferable to set the saturation levels of the high-sensitivity pixel and low-sensitivity pixel to substantially the same level or set higher the saturation level of the low-sensitivity pixel. This is expressed by the following expression.

VSAT1/SENS1<VSAT2/SENS2 (4)

When the above expression is satisfied, the dynamic range can be expanded.

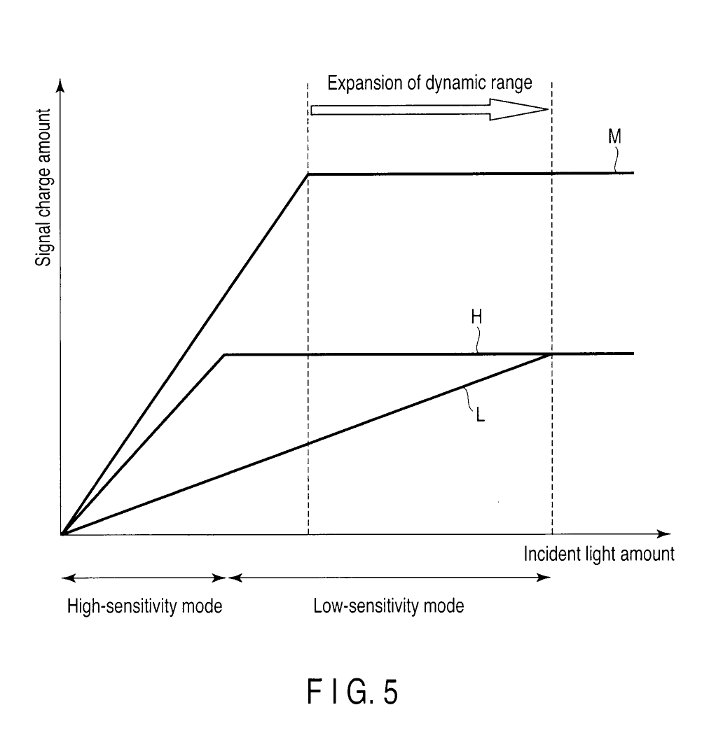

FIG. 5 is a diagram showing an example of the characteristics for illustrating the dynamic range expanding effect of the CMOS image sensor of this embodiment. In FIG. 5, the abscissa indicates an incident light amount and the ordinate indicates a signal charge amount generated in the photodiode. In this example, H indicates the characteristic of a high-sensitivity pixel (PD1), L indicates the characteristic of a low-sensitivity pixel (PD2) and M indicates the characteristic of a pixel (conventional pixel) of the conventional unit cell.

In this embodiment, the light sensitivity of high-sensitivity pixel H is set to ¾ of that of the conventional pixel and the light sensitivity of low-sensitivity pixel L is set to ¼ of that of the conventional pixel. Further, the saturation level of high-sensitivity pixel H is set to ½ of that of conventional pixel M and the saturation level of low-sensitivity pixel L is set to ½ of that of conventional pixel M.

As is understood from FIG. 5, since the light sensitivity of high-sensitivity pixel H is set to ¾ of that of conventional pixel M and the light sensitivity of low-sensitivity pixel L is set to ¼ of that of conventional pixel M, the signal charge amount becomes equivalent to that of conventional pixel M in the high-sensitivity mode in which outputs of high-sensitivity pixel H and light sensitivity of low-sensitivity pixel L are added together.

Since the saturation level of low-sensitivity pixel L is set to ½ of that of conventional pixel M and the light sensitivity thereof is set to ¼ of that of the conventional pixel, the range in which low-sensitivity pixel L is operated without being saturated is increased to twice that of conventional pixel M. That is, it is understood that the dynamic range is increased to twice that of conventional pixel M in the low-sensitivity mode in which an output of low-sensitivity pixel L is used.

Next, the relationship between lens pitch, interconnection pitch and pixel pitch that are the additional feature of this embodiment is explained.

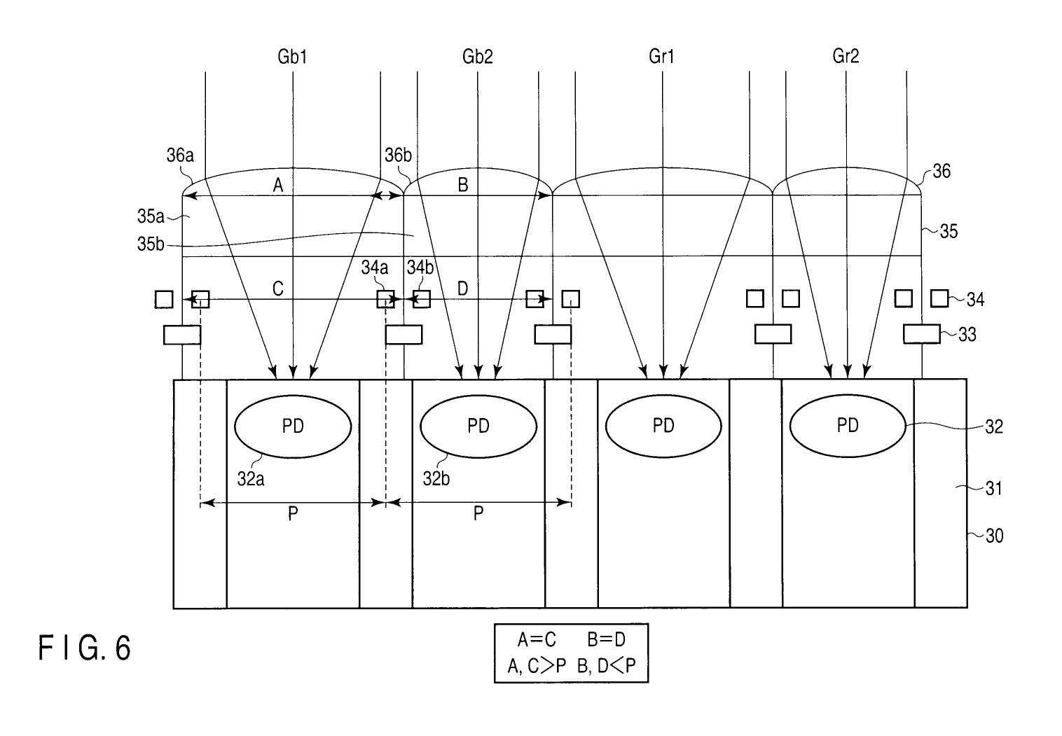

FIG. 6 is a cross-sectional view showing the relationship between microlenses, interconnection lines and pixels in the present embodiment. In the drawing, 30 indicates a semiconductor substrate, 31 an element isolation insulating film, 32 a pixel, 33, 34 interconnection lines, 35 a color filter and 36 a microlens.

The pixels 32 are arranged at preset pitch P and adjacent two of the pixels 32 are isolated by the element isolation insulating film 31. Each pixel 32 is configured by two types of pixels including a high-sensitivity pixel 32a and low-sensitivity pixel 32b, aperture A of the high-sensitivity pixel 32a is defined by a microlens 36a and aperture B of the low-sensitivity pixel 32b is defined by a microlens 36b. That is, the pitch of the microlens 36a is set larger than the pitch of the microlens 36b and aperture A of the high-sensitivity pixel 32a is set larger than aperture B of the low-sensitivity pixel 32b. The lower-layered interconnection lines 33 correspond to output signal VSIG and the upper-layered interconnection lines 34 correspond to signal lines ADRES, RESET, READ. In this case, particularly, the upper-layered interconnection line 34 is shown to be separated into a high-sensitivity pixel line 34a and low-sensitivity pixel line 34b.

The pitch of the microlens 36a is a distance between the boundaries between the microlens 36a and two microlenses 36b adjacent thereto as viewed from a line passing through the center of the lens. Likewise, the pitch of the microlens 36b is a distance between the boundaries between the microlens 36b and two microlenses 36a adjacent thereto as viewed from a line passing through the center of the lens. Definition of the pitch is the same as that for the color filter 35 and interconnection lines 33, 34.

The color filter 35 is configured by two types of filters including high-sensitivity pixel filters 35a and low-sensitivity pixel filters 35b that have the same pitches as those of corresponding lenses of the microlens 36. That is, aperture A of the high-sensitivity pixel 32a is the same as the pitch of the microlens 36a and color filter 35a and aperture B of the low-sensitivity pixel 32b is the same as the pitch of the microlens 36b and color filter 35b.

In this case, the interconnection pitch is not the same as pixel pitch P and, in this embodiment, high-sensitivity interconnection pitch C is set larger than low-sensitivity interconnection pitch D. That is, the boundary (in this example, the intermediate point between the interconnection lines 34a and 34b above the interconnection line 33) between high-sensitivity interconnection pitch C and low-sensitivity interconnection pitch D coincides with the boundary between aperture A of the high-sensitivity pixel 32a and aperture B of the low-sensitivity pixel 32b.

Therefore, the following equations are obtained.

A=C, B=D

Further, PDs (photodiodes) 32 formed in the semiconductor substrate 30 are successively formed at regular intervals with respect to the high-sensitivity pixels 32a and low-sensitivity pixels 32b. That is, if the pixel (PD) pitch is set to P, the following relationships are set.

A=C>P, B=D<P

That is, “high-sensitivity pixel aperture A and high-sensitivity pixel interconnection pitch C are equal and set larger than pixel pitch P” and “low-sensitivity pixel aperture B and low-sensitivity pixel interconnection pitch D are equal and set smaller than pixel pitch P”.

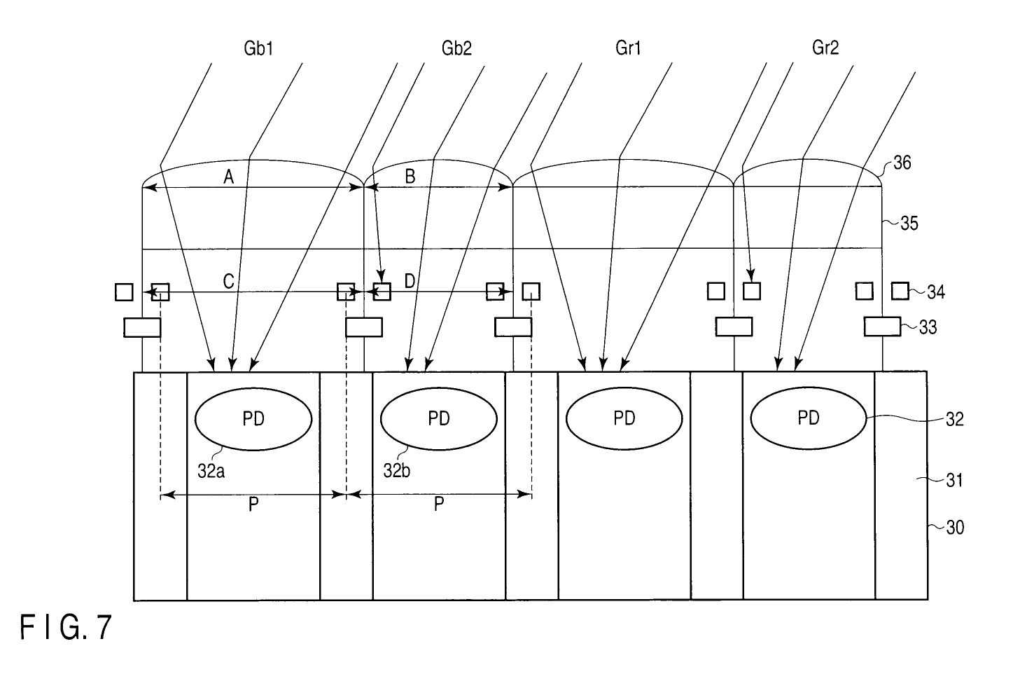

Thus, incident light can be prevented from being shielded by the interconnection lines 33, 34 even in the high-sensitivity pixels 32a when light is made incident with a high angle of incidence as shown in FIG. 7 by setting the interconnection pitch of each of the high-sensitivity pixels 32a and low-sensitivity pixels 32b equal to the aperture pitch. That is, occurrence of an eclipse in the high-sensitivity pixels 32a can be prevented.

In this case, the numerical aperture of the low-sensitivity pixels 32b becomes lower than the numerical aperture of the high-sensitivity pixels 32a, but since the angle of view of incident light to the low-sensitivity pixels 32b is smaller than that of the high-sensitivity pixels 32a, an increase in the eclipse of incident light is small.

As described above, in the CMOS image sensor of this embodiment, it is possible to obtain the effect that the dynamic range can be expanded by utilizing the low-sensitivity mode and degradation in the light sensitivity when a light amount is small (in a dark case) can be suppressed by utilizing the high-sensitivity mode. That is, the relationship of tradeoff (antinomy) of the light sensitivity and signal charge treating amount is overcome and the signal charge treating amount can be made large while low noise at the dark time is maintained.

In addition, in this embodiment, occurrence of an eclipse of incident light with respect to the high-sensitivity pixel can be prevented by setting high-sensitivity pixel interconnection pitch C equal to high-sensitivity pixel aperture A and larger than one pixel pitch P and setting low-sensitivity pixel interconnection pitch D equal to low-sensitivity pixel aperture B and smaller than one pixel pitch P.

Further, in this embodiment, the dynamic range of the CMOS image sensor can be expanded and a high-speed sensor whose frame rate is high can be easily designed by utilizing the advantage of the CMOS image sensor, that is, a thinning operation or the like.

In the CMOS image sensor of this embodiment, when attention is paid only to PD1 or PD2, since the arrangement thereof is an RGB Bayer array generally used, output signals in the high-sensitivity mode and low-sensitivity mode correspond to the RGB Bayer array. Therefore, as a color signal process such as de-mosaic, the conventional process can be used as it is.

Further, in the CMOS image sensor of this embodiment, PD1, PD2 are arranged in a checkered form. Therefore, as shown in FIG. 2A, various components can be easily laid out in the pixel by arranging FD between PD1 and PD2 and arranging respective transistors (AMP, RST) in a remaining space area.

<Modification of First Embodiment>

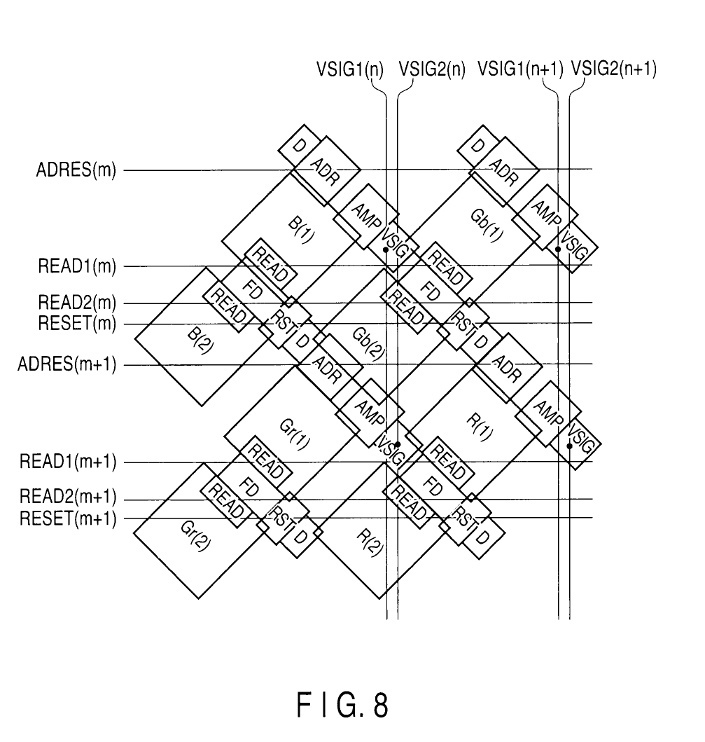

FIG. 8 is a view schematically showing a part of a layout image of an element forming region and gates in an imaging region of a CMOS image sensor according to a modification of the first embodiment together with signal lines.

In FIG. 8, signal lines include signal lines ADRES(m), RESET(m), READ1(m), READ2(m) of an mth row, signal lines ADRES(m+1), RESET(m+1), READ1(m+1), READ2(m+1) of an (m+1)th row, two vertical signal lines VSIG1(n), VSIG2(n) of an nth column and two vertical signal lines VSIG1(n+1), VSIG2(n+1) of an (n+1)th column. The layout of color filters and microlenses is the same as the layout in the first embodiment shown in FIG. 2B.

Like the first embodiment, in the CMOS image sensor of this modification, a high-sensitivity pixel and low-sensitivity pixel are arranged in a unit cell, a microlens with a large area is arranged on the high-sensitivity pixel and a microlens with a small area is arranged on the low-sensitivity pixel. In this case, two vertical signal lines are arranged for each column of the imaging region and an output of a pixel source follower is connected to a different vertical signal line for every other row of the imaging region to enhance the frame rate (the number of screens that can be output for each second). As a result, signals of pixels of two rows can be simultaneously read.

In the description of the above embodiment, the terms “high-sensitivity” and “low-sensitivity” were used. The term “low-sensitivity” was intended to simply mean that the sensitivity is lower than the “high” sensitivity. In other words, the term “low-sensitivity” may be expressed as “normal sensitivity” or as “high-sensitivity” depending upon the circumstances. In general, cameras are described as having “a high-sensitivity mode” or “a normal-sensitivity mode.”

### Second Embodiment

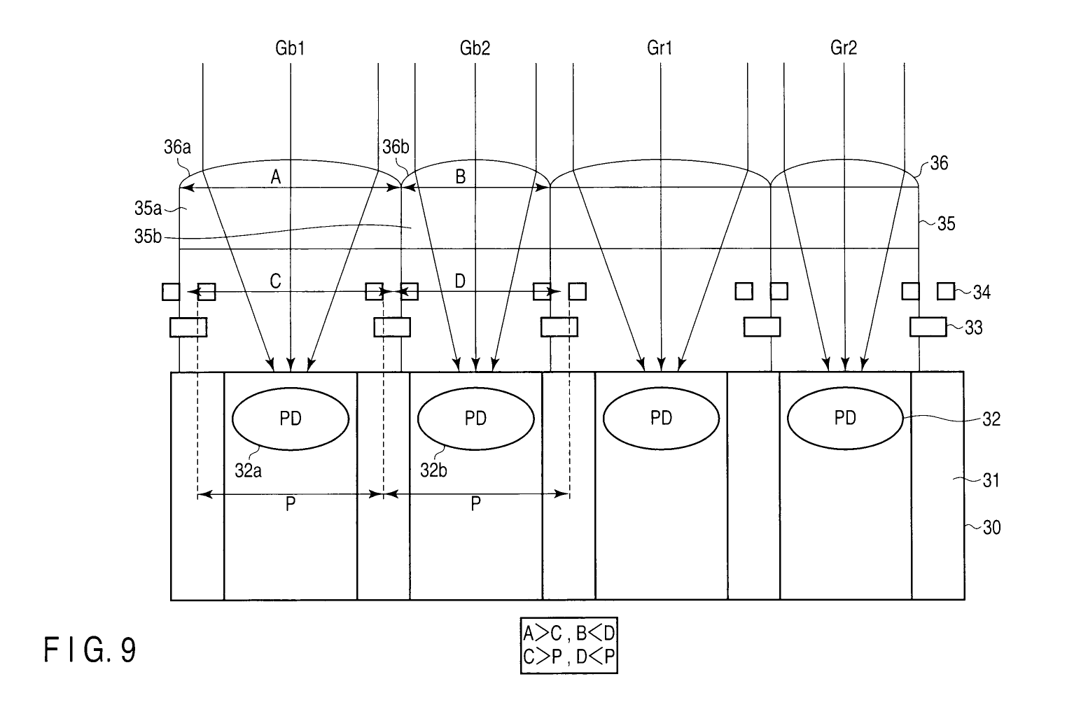

FIG. 9 is a cross-sectional view showing the arrangement relationship between microlenses, interconnection lines and pixels, for illustrating a solid-state imaging device according to a second embodiment. Portions that are the same as those of FIG. 6 are denoted by the same symbols and the detailed explanation thereof is omitted.

Like the first embodiment, each pixel is configured by two types of pixels including a high-sensitivity pixel 32a and low-sensitivity pixel 32b, and aperture A of the high-sensitivity pixel 32a is made larger than aperture B of the low-sensitivity pixel 32b. In this case, the boundary between high-sensitivity pixel pitch C and low-sensitivity pixel pitch D does not coincide with the boundary between aperture A of the high-sensitivity pixel 32a and aperture B of the low-sensitivity pixel 32b and the following relationships are set.

A>C, B<D

Further, PDs 32 formed in the semiconductor substrate 30 are successively formed at regular intervals with respect to the high-sensitivity pixels 32a and low-sensitivity pixels 32b. If pixel (PD) pitch P is taken into consideration, the following relationships are set.

A>C>P, B<D<P

That is, “high-sensitivity pixel interconnection pitch C is smaller than high-sensitivity pixel aperture A and set larger than pixel pitch P” and “low-sensitivity pixel interconnection pitch D is larger than low-sensitivity pixel aperture B and set smaller than pixel pitch P”.

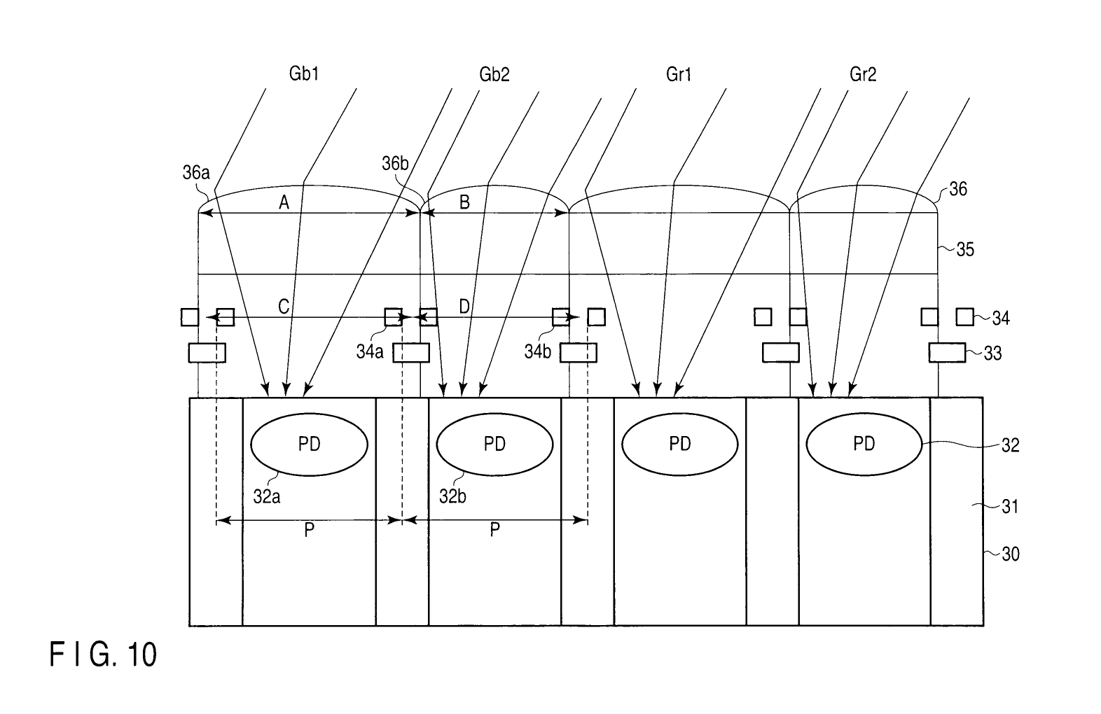

In the first embodiment described before, since the dimension of low-sensitivity pixel interconnection pitch D is set equal to that of aperture B of the low-sensitivity pixel 32b, the numeric aperture of the low-sensitivity pixel 32b is lowered in comparison with the numeric aperture of the high-sensitivity pixel 32a and there occurs a possibility that an eclipse occurs. On the other hand, in this embodiment, the numeric aperture of the pixel can be improved over that of the first embodiment by making a design to set low-sensitivity pixel interconnection pitch D larger than aperture B of the low-sensitivity pixel 32b and smaller than pixel pitch P. Therefore, as shown in FIG. 10, light is not shielded by the low-sensitivity pixel interconnection lines 34b and an eclipse of incident light occurring in the low-sensitivity pixels 32b can be reduced even when light with a high angle of incidence is made incident to the low-sensitivity pixel 32b.

That is, eclipses of light occurring in the high-sensitivity pixel 32a and low-sensitivity pixel 32b can be reduced by setting high-sensitivity pixel interconnection pitch C and low-sensitivity pixel interconnection pitch D to optimum values. Therefore, deviation in the sensitivity ratio of the high-sensitivity pixel 32a to the low-sensitivity pixel 32b can be suppressed and a solid-state imaging device with a wide dynamic range using the high-sensitivity pixels 32a and low-sensitivity pixels 32b can be realized.

### Third Embodiment

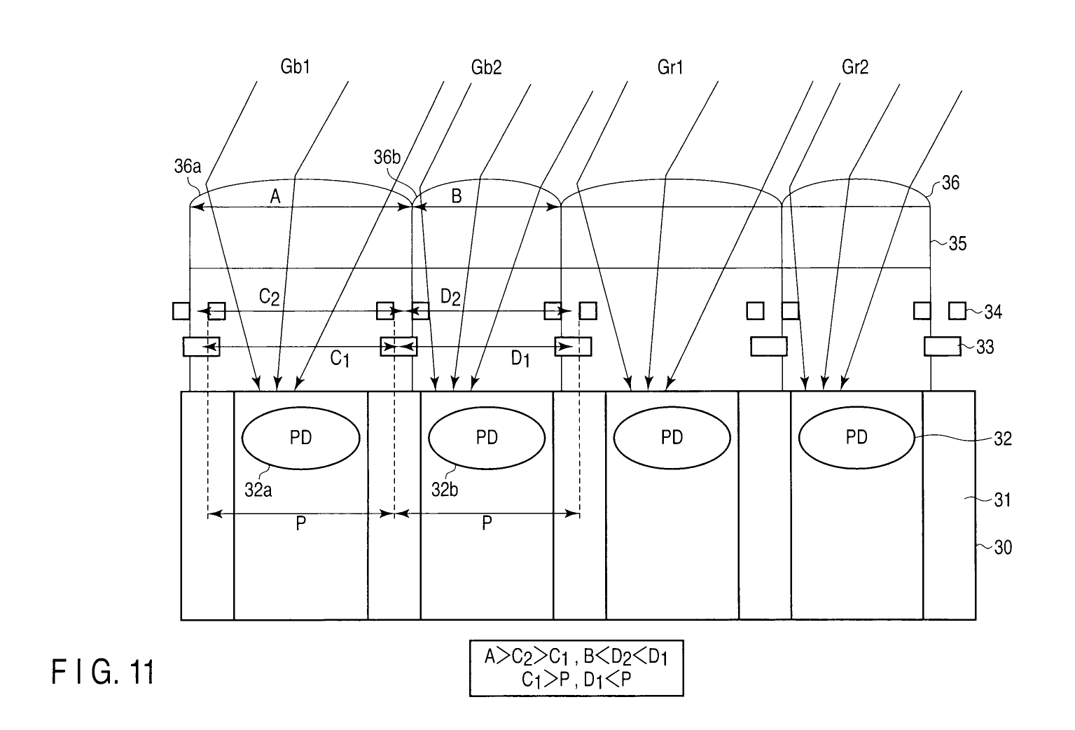

FIG. 11 is a cross-sectional view showing the arrangement relationship between microlenses, interconnection lines and pixels, for illustrating a solid-state imaging device according to a third embodiment. Portions that are the same as those of FIG. 6 are denoted by the same symbols and the detailed explanation thereof is omitted.

Like the first embodiment, each pixel is configured by two types of pixels including a high-sensitivity pixel 32a and low-sensitivity pixel 32b and aperture A of the high-sensitivity pixel 32a is made larger than aperture B of the low-sensitivity pixel 32b. In this case, it is assumed that the pitch of a first-layered interconnection line 33a of the high-sensitivity pixel 32a is C1, the pitch of a first-layered interconnection line 33b of the low-sensitivity pixel is D1, the pitch of a second-layered interconnection line 34a of the high-sensitivity pixel 32a is C2, and the pitch of a second-layered interconnection line 34b of the low-sensitivity pixel 32b is D2. The boundary between aperture A of the high-sensitivity pixel 32a and aperture B of the low-sensitivity pixel 32b does not coincide with the boundary between the high-sensitivity pixel interconnection pitch and the low-sensitivity pixel interconnection pitch of each interconnection layer and the structure in which the following relationships are set can be obtained.

A>C2>C1, B<D2<D1

Further, PDs 32 formed in a semiconductor substrate 30 are successively formed at equal intervals with respect to the high-sensitivity pixels 32a and low-sensitivity pixels 32b. If pixel (PD) pitch P is taken into consideration, the following relationships are set.

A>C2>C1>P, B<D2<D1<P

Thus, the present structure is different from that in which the whole interconnection layers of the second embodiment are uniformly moved and deviation in the sensitivity ratio of the high-sensitivity pixel 32a to the low-sensitivity pixel 32b can be more effectively suppressed in comparison with that in the second embodiment by determining the pixel interconnection pitch of each interconnection layer. Therefore, a solid-state imaging device with a wider dynamic range using the high-sensitivity pixels 32a and low-sensitivity pixels 32b can be realized.

The interconnection layer is not necessarily formed with a two-layered structure but may be formed with a three- or more-layered structure. In the case of the three- or more-layered structure, the interconnection pitch may be set larger in the upper-side layer of the high-sensitivity pixel and the interconnection pitch may be set smaller in the upper-side layer of the low-sensitivity pixel.

### Fourth Embodiment

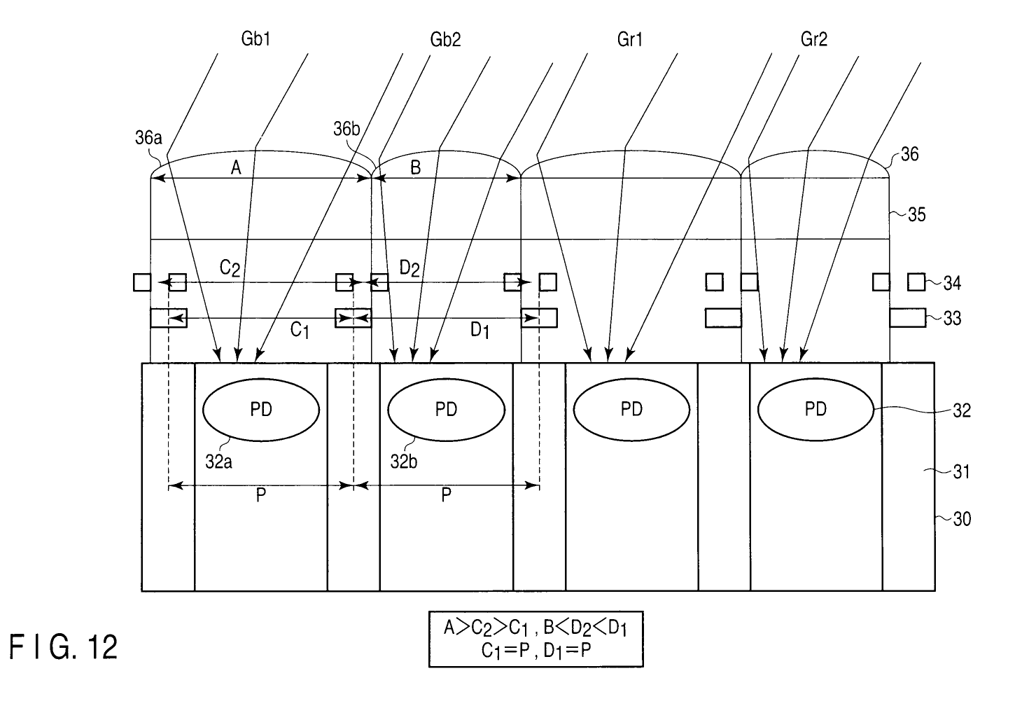

FIG. 12 is a cross-sectional view showing the arrangement relationship between microlenses, interconnection lines and pixels, for illustrating a solid-state imaging device according to a fourth embodiment. Portions that are the same as those of FIG. 6 are denoted by the same symbols and the detailed explanation thereof is omitted.

The basic configuration is the same as that of the third embodiment explained before and the present embodiment is different from the third embodiment in that the pitches of first-layered interconnection lines 33a, 33b of high-sensitivity pixels 32a and low-sensitivity pixels 32b are set equal to pixel pitch P.

That is, the following relationships are set.

A>C2>C1=P, B<D2<D1=P

Thus, the relationship between the first interconnection pitch and the pixel pitch of this embodiment is expressed as follows.

“pitch C1 of high-sensitivity pixel first-layered interconnection line 33a is set equal to pixel pitch P” and “pitch D1 of low-sensitivity pixel first-layered interconnection line 33b is set equal to pixel pitch P”

This means that the first-layered interconnection pitch and pixel pitch P have the same pitch.

As a result, an eclipse occurring in the low-sensitivity pixel 32b can be suppressed in a second-layered interconnection layer (TOP interconnection layer) and a first-layered interconnection layer (lowermost interconnection layer) can reduce optical crosstalk with respect to adjacent pixels, prevent light from being made incident to a diffusion layer that separates PDs of respective pixels and suppress occurrence of crosstalk of carriers.

As described above, with the structure of this embodiment, a solid-state imaging device with a wide dynamic range using the high-sensitivity pixels 32a and low-sensitivity pixels 32b and an solid-state imaging device with a low degree of a mixture of colors can be realized.

(Modification)

This invention is not limited to the above embodiments. In the above embodiments, the CMOS image sensor is explained as an example, but this invention is not limited to the CMOS image sensor and can be applied to a CCD image sensor. Further, the circuit configuration shown in FIG. 1 is shown as an example and this invention can be applied to various types of solid-state imaging devices including high-sensitivity pixels and low-sensitivity pixels.

Further, the constituents of the device structure shown in FIG. 6 are provided only as one example and can be adequately changed according to specifications. For example, the microlens is indispensable to set aperture A larger than pixel pitch P in the high-sensitivity pixel, but the microlens can be omitted since aperture B is set smaller than pixel pitch P in the low-sensitivity pixel.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a photodiode module in which first photodiodes corresponding to high-sensitivity pixels and second photodiodes corresponding to low-sensitivity pixels are alternately arranged at preset pitch P in a semiconductor substrate,
high-sensitivity pixel interconnection lines provided at preset pitch C on the substrate,
low-sensitivity pixel interconnection lines provided at preset pitch D on the substrate,
high-sensitivity pixel color filters provided at preset pitch A on an opposite side of the respective interconnection lines with respect to the substrate to limit a wavelength of incident light to the high-sensitivity pixels, and
low-sensitivity pixel color filters provided at preset pitch B on the opposite side of the respective interconnection lines with respect to the substrate to limit a wavelength of incident light to the low-sensitivity pixels,
wherein pitch A is larger than pitch B, pitch C is equal to pitch A and larger than pitch P and pitch D is equal to pitch B and smaller than pitch P.

2. The device according to claim 1, further comprising high-sensitivity pixel microlenses that define apertures of the high-sensitivity pixels and low-sensitivity pixel microlenses that define apertures of the low-sensitivity pixels,
wherein the pitch of the high-sensitivity pixel microlenses is the same as pitch A and the pitch of the low-sensitivity pixel microlenses is the same as pitch B.

3. The device according to claim 2, wherein the high-sensitivity pixel microlenses and low-sensitivity pixel microlenses are arranged in a checkered form.

4. The device according to claim 1, further comprising:
first read transistors each of which is connected to the first photodiode and configured to read signal charges,
second read transistors each of which is connected to the second photodiode and configured to read signal charges,
floating diffusion nodes each of which is connected to the first read transistors and the second read transistors and stores the read signal charges read by the above transistors,
reset transistors configured to reset potentials of the floating diffusion nodes, and
amplification transistors configured to amplify the potentials of the floating diffusion nodes.

5. The device according to claim 4, wherein the device has a first operation mode in which a signal obtained by amplifying the potential of the floating diffusion node when the signal charges of the first and second photodiodes are added at the floating diffusion node is output, and a second operation mode in which a signal obtained by amplifying the potential of the floating diffusion node when the signal charges of the second photodiode is read by the second read transistor is output.

6. The device according to claim 4, wherein the device has a first operation mode in which a signal obtained by separately reading the signal charges of the first and second photodiodes is output, and a second operation mode in which a signal obtained by reading the signal charges of the second photodiode is output.

7. The device according to claim 5, wherein the relationship of VSAT1/SENS1<VSAT2/SENS2 is satisfied when light sensitivity of the first photodiode is SENS1, a saturation level thereof is VSAT1, light sensitivity of the second photodiode is SENS2 and a saturation level thereof is VSAT2.

8. A solid-state imaging device comprising:
a photodiode module in which first photodiodes corresponding to high-sensitivity pixels and second photodiodes corresponding to low-sensitivity pixels are alternately arranged at preset pitch P in a semiconductor substrate,
high-sensitivity pixel interconnection lines provided at preset pitch C on the substrate,
low-sensitivity pixel interconnection lines provided at preset pitch D on the substrate,
high-sensitivity pixel color filters provided at preset pitch A on an opposite side of the respective interconnection lines with respect to the substrate to limit a wavelength of incident light to the high-sensitivity pixels, and
low-sensitivity pixel color filters provided at preset pitch B on the opposite side of the respective interconnection lines with respect to the substrate to limit a wavelength of incident light to the low-sensitivity pixels,
wherein pitch A is larger than pitch B, pitch C is smaller than pitch A and larger than pitch P and pitch D is larger than pitch B and smaller than pitch P.

9. The device according to claim 8, further comprising high-sensitivity pixel microlenses that define apertures of the high-sensitivity pixels and low-sensitivity pixel microlenses that define apertures of the low-sensitivity pixels,
wherein the pitch of the high-sensitivity pixel microlenses is the same as pitch A and the pitch of the low-sensitivity pixel microlenses is the same as pitch B.

10. The device according to claim 9, wherein the high-sensitivity pixel microlenses and low-sensitivity pixel microlenses are arranged in a checkered form.

11. The device according to claim 8, further comprising:
first read transistors each of which is connected to the first photodiode and configured to read signal charges,
second read transistors each of which is connected to the second photodiode and configured to read signal charges,
floating diffusion nodes each of which is connected to the first read transistors and the second read transistors and stores the signal charges read by the above transistors,
reset transistors configured to reset potentials of the floating diffusion nodes, and
amplification transistors configured to amplify the potentials of the floating diffusion nodes.

12. The device according to claim 11, wherein the device has a first operation mode in which a signal obtained by amplifying the potential of the floating diffusion node when the signal charges of the first and second photodiodes are added at the floating diffusion node is output, and a second operation mode in which a signal obtained by amplifying the potential of the floating diffusion node when the signal charges of the second photodiode is read by the second read transistor is output.

13. The device according to claim 11, wherein the device has a first operation mode in which a signal obtained by separately reading the signal charges of the first and second photodiodes is output, and a second operation mode in which a signal obtained by reading the signal charges of the second photodiode is output.

14. The device according to claim 12, wherein the relationship of VSAT1/SENS1<VSAT2/SENS2 is satisfied when light sensitivity of the first photodiode is SENS1, a saturation level thereof is VSAT1, light sensitivity of the second photodiode is SENS2 and a saturation level thereof is VSAT2.

15. A solid-state imaging device comprising:
a photodiode module in which first photodiodes corresponding to high-sensitivity pixels and second photodiodes corresponding to low-sensitivity pixels are alternately arranged at preset pitch P in a semiconductor substrate,
high-sensitivity pixel interconnection lines provided in a plural-layered form on the substrate with pitch C1 on a lower-layered side being set smaller than pitch C2 on an upper-layered side,
low-sensitivity pixel interconnection lines provided in a plural-layered form on the substrate with pitch D1 on a lower-layered side being set larger than pitch D2 on an upper-layered side,
high-sensitivity pixel color filters provided at preset pitch A on an opposite side of the respective interconnection lines with respect to the substrate to limit a wavelength of incident light to the high-sensitivity pixels, and
low-sensitivity pixel color filters provided at preset pitch B on the opposite side of the respective interconnection lines with respect to the substrate to limit a wavelength of incident light to the low-sensitivity pixels,
wherein pitch A is larger than pitch B, pitch C1 is not smaller than pitch P, pitch C2 is smaller than pitch A, pitch D1 is not larger than pitch P and pitch D2 is larger than pitch B.

16. The device according to claim 15, further comprising high-sensitivity pixel microlenses that define apertures of the high-sensitivity pixels and low-sensitivity pixel microlenses that define apertures of the low-sensitivity pixels,
wherein the pitch of the high-sensitivity pixel microlenses is the same as pitch A and the pitch of the low-sensitivity pixel microlenses is the same as pitch B.

17. The device according to claim 16, wherein the high-sensitivity pixel microlenses and low-sensitivity pixel microlenses are arranged in a checkered form.

18. The device according to claim 15, further comprising:
first read transistors each of which is connected to the first photodiode and configured to read signal charges,
second read transistors each of which is connected to the second photodiode and configured to read signal charges,
floating diffusion nodes each of which is connected to the first read transistors and the second read transistors and stores the read signal charges read by the above transistors,
reset transistors configured to reset potentials of the floating diffusion nodes, and
amplification transistors configured to amplify the potentials of the floating diffusion nodes.

19. The device according to claim 18, wherein the device has a first operation mode in which a signal obtained by amplifying the potential of the floating diffusion node when the signal charges of the first and second photodiodes are added at the floating diffusion node is output, and a second operation mode in which a signal obtained by amplifying the potential of the floating diffusion node when the signal charges of the second photodiode is read by the second read transistor is output.

20. The device according to claim 18, wherein the device has a first operation mode in which a signal obtained by separately reading the signal charges of the first and second photodiodes is output, and a second operation mode in which a signal obtained by reading the signal charges of the second photodiode is output.
